(19) United States
(12) Patent Application Publication
(10) Pub. No.: US 2024/0321248 A1
(43) Pub. Date: Sep. 26, 2024

(54) KEYBOARD INSTRUMENT FABRICATING METHOD AND KEYBOARD INSTRUMENT

(71) Applicant: CASIO COMPUTER CO., LTD., Tokyo (JP)

(72) Inventors: Naoto IMAMURA, Tokyo (JP); Otoya SAKAI, Tokyo (JP)

(21) Appl. No.: 18/606,746

(22) Filed: Mar. 15, 2024

(30) Foreign Application Priority Data
Mar. 24, 2023 (JP) 2023-047952

(51) Int. Cl. G10H 1/34

(52) U.S. Cl. CPC G10H 1/34; G10H 2220/221

(57) ABSTRACT

A keyboard instrument fabricating method is configured to assemble a keyboard including multiple keys into an instrument case through a concave-convex engagement structure, wherein the concave-convex engagement structure includes a concave groove portion and a convex portion, wherein the concave groove portion is provided on either of the keyboard and the instrument case and includes a left-right groove and a front-back groove configured to communicate with the left-right groove, wherein the convex portion is provided on the other of the keyboard and the instrument case and is configured to be brought into engagement with the concave groove portion, and has a front-back groove engagement step of bringing the convex portion into engagement with the front-back groove and a left-right groove engagement step of bringing the convex portion into engagement with the left-right groove.

### CROSS-REFERENCE TO RELATED APPLICATION

This application is based upon and claims the benefit of priority under 35 USC 119 of Japanese Patent Application No. 2023-047952 filed on Mar. 24, 2023, the entire disclosure of which, including the specification, claims, drawings, and abstract, is incorporated herein by reference in its entirety.

### BACKGROUND

### Technical Field

The present disclosure relates to a keyboard instrument fabricating method and a keyboard instrument.

### Description of the Related Art

There have conventionally been provided keyboard instruments in which a keyboard such as a keyboard chassis including multiple keys is attached to a shelf plate constituting a lower surface of an instrument case. For example, Japanese Unexamined Patent Application Publication No. 2006-047837 discloses a keyboard instrument including a keyboard chassis including a connection bar connected with an instrument case. The fixation of the keyboard chassis to the shelf plate is executed by attaching a screw element from a lower surface side of the shelf plate via a reinforcement rib attached to a lower surface of the shelf plate.

### SUMMARY

According to an aspect of the present disclosure, there is provided a keyboard instrument fabricating method for assembling a keyboard including multiple keys into an instrument case through a concave-convex engagement structure, wherein the concave-convex engagement structure includes a concave groove portion and a convex portion, wherein the concave groove portion is provided on either of the keyboard and the instrument case and includes a left-right groove and a front-back groove configured to communicate with the left-right groove, wherein the convex portion is provided on the other of the keyboard and the instrument case and is configured to be brought into engagement with the concave groove portion, the keyboard instrument fabricating method including a front-back groove engagement step of bringing the convex portion into engagement with the front-back groove and a left-right groove engagement step of bringing the convex portion into engagement with the left-right groove.

According to another aspect of the present disclosure, there is provided a keyboard instrument including an instrument case including either of a concave groove portion and a convex portion, wherein the concave groove portion includes a left-right groove and a front-back groove configured to communicate with the left-right groove, wherein the convex portion is configured to be brought into engagement with the concave groove portion and a keyboard disposed within the instrument case and including the other of the concave groove portion and the convex portion, wherein the instrument case and the keyboard are brought into engagement with each other through an engagement structure made up of the concave groove portion and the convex portion to thereby fix the keyboard to the instrument case.

### BRIEF DESCRIPTION OF THE DRAWINGS

FIG. 1 is a perspective view showing a keyboard instrument according to an embodiment of the present disclosure;

FIG. 2 is a sectional view of the keyboard instrument according to the embodiment of the present disclosure taken along a line II-II in FIG. 1;

FIG. 3 is a perspective view, as viewed from a back side, of a state in which a front plate and a shelf plate of the keyboard instrument according to the embodiment of the present disclosure are assembled together;

FIG. 4 is a perspective view, as viewed from a front side, of a keyboard chassis of the keyboard instrument according to the embodiment of the present disclosure;

FIG. 5 is a perspective view, as viewed from the back side, of the keyboard chassis of the keyboard instrument according to the embodiment of the present disclosure;

FIG. 6 is a perspective view, as viewed from a front upper side, of a mount of the keyboard instrument according to the embodiment of the present disclosure;

FIG. 7 is a perspective view, as viewed from back lower side, of the mount of the keyboard instrument according to the embodiment of the present disclosure;

FIG. 8 is an explanatory drawing of an assembly method of the keyboard instrument according to the embodiment of the present disclosure, specifically, a plan view of a state in which the mount is placed on the shelf plate to which the front plate is connected;

FIG. 9 is an explanatory drawing of the assembly method of the keyboard instrument according to the embodiment of the present disclosure, specifically, a sectional view corresponding to a section taken along a line IX-IX in FIG. 8, which shows a state in which the keyboard chassis supporting multiple keys is fitted in the mount shown in FIG. 8, the multiple keys being shown not in section, with some other constituent components such as a circuit board, a switch, and the like omitted from illustration;

FIG. 10 is an explanatory drawing of the assembly method of the keyboard instrument according to the embodiment of the present disclosure, specifically, a plan view showing a state in which the keyboard chassis supporting multiple keys is placed on and fitted in the mount;

FIG. 11 is an explanatory drawing of the assembly method of the keyboard instrument according to the embodiment of the present disclosure, specifically, a sectional view corresponding to a section taken along a line XI-XI in FIG. 10, which shows a state in which the keyboard chassis is placed on and fitted in the mount, the multiple keys being shown not in section, with some other constituent components such as a circuit board, a switch, and the like omitted from illustration;

FIG. 12 is an explanatory drawing of the assembly method of the keyboard instrument according to the embodiment of the present disclosure, specifically, a sectional view corresponding to a section taken along the line XI-XI in FIG. 10, which shows a state in which the keyboard is advanced from the state shown in FIG. 11, the multiple keys being shown not in section, with some other constituent components such as a circuit board, a switch, and the like omitted from illustration;

FIG. 13 is an explanatory drawing of the assembly method of the keyboard instrument according to the embodiment of the present disclosure, specifically, a plan view showing a state in which the keyboard is moved to a front side and a right side to be positioned in a regular position, and a fixing unit and a rotational unit are attached thereto; and

FIG. 14 is a perspective view, as viewed from a lower side, of the rotational unit of the keyboard instrument according to the keyboard instrument according to the embodiment of the present disclosure.

### DESCRIPTION OF THE EMBODIMENT

A conventional assemblage of a keyboard instrument involves troublesome and complicated work of tightening multiple screws by a worker who goes underneath an instrument case or tightening multiple screws by turning over the instrument case using a jig for supporting a keyboard chassis and a connection bar. In contrast with this configuration, the present disclosure can provide a keyboard instrument fabricating method and a keyboard instrument that can provide good assembly of a keyboard into an instrument case.

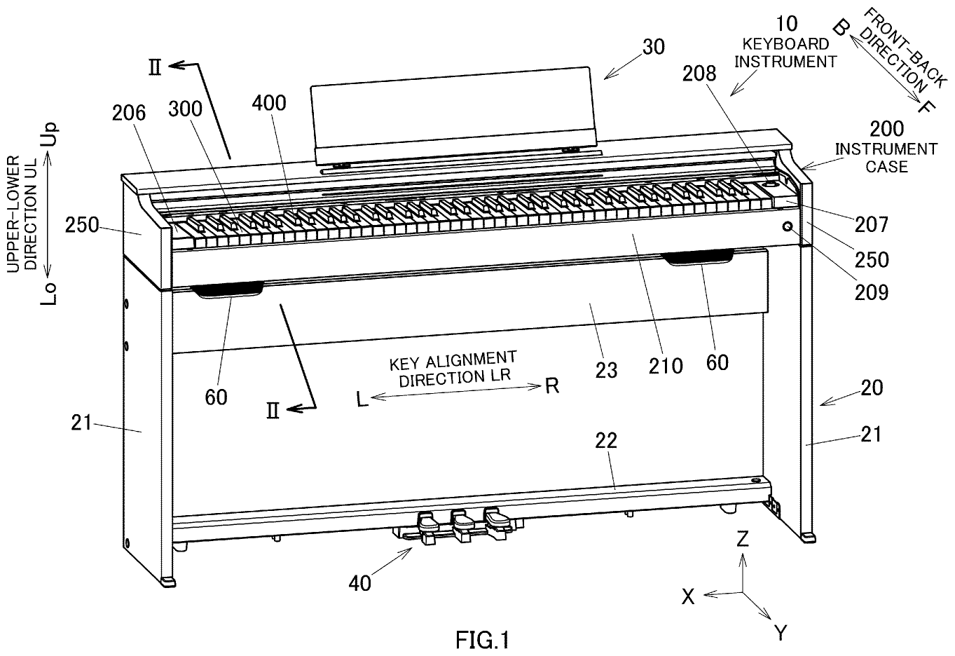

Hereinafter, an embodiment of the present disclosure will be described based on accompanying drawings. As shown in FIG. 1, a keyboard instrument 10 is such that multiple keys of full notes (88 notes) including multiple white keys 300 and multiple black keys 400 are provided in an instrument case 200. The keyboard instrument 10 has a music stand 30 detachably mounted on the instrument case 200 and is supported by an instrument stand 20.

Here, in the following description, a front of the multiple keys (the white keys 300, the black keys 400) in a front-back direction FB is referred to as a front side F (a positive side in a y-axis), and a back of the keys in the front-back direction FB is referred to as a back side B (a negative side in the y-axis). Then, when standing to face the keys, a left is referred to as a left side L (a positive side of an x-axis), and a right is referred to as a right side R (a negative side in the x-axis). An alignment direction LR of the keys is referred to as a left-right direction. In addition, in an upper-lower direction UL of the keyboard instrument 10, an upward direction is understood to denote an upper side Up (a positive side in a z-axis), and a downward direction is understood to denote a lower side Lo (a negative side in the z-axis).

A left wing 206 and a right wing 207, each having substantially a rectangular parallelepiped box shape which is elongated in the front-back direction FB, are provided on the left side L and the right side R of the multiple keys (the white keys 300, the black keys 400), respectively. A volume control knob 208 is provided on an upper surface of the right wing 207. In addition, a power supply push-button 209 is provided in the vicinity of a right end of a front plate 210 of the instrument case 200, which will be described later.

The instrument stand 20 has left and right side plates 21. The instrument stand 20 includes a lower beam 22, which is long in the key alignment direction LR and is provided in such a manner as to span the left and right side plates 21 at back lower portions thereof. A pedal device 40 is provided substantially at a central portion of the lower beam 22 in the key alignment direction LR. An upper beam 23 having a plate shape is provided above the lower beam 22. The keyboard instrument 10 is fixed to tops of the left and right side plates 21.

The instrument case 200 of the keyboard instrument 10 is provided in such a manner that a left surface (an outer surface of a left side plate 250) and a right surface (an outer surface of a right side plate 250) are contiguous with outer surfaces of the left and right side plates 21 of the instrument stand 20. In addition, loudspeaker covers 60, which protrude downwards, are provided individually leftwards and rightwards on a lower surface of the keyboard instrument 10 in such a manner as to be disposed between the left and right side plates 21.

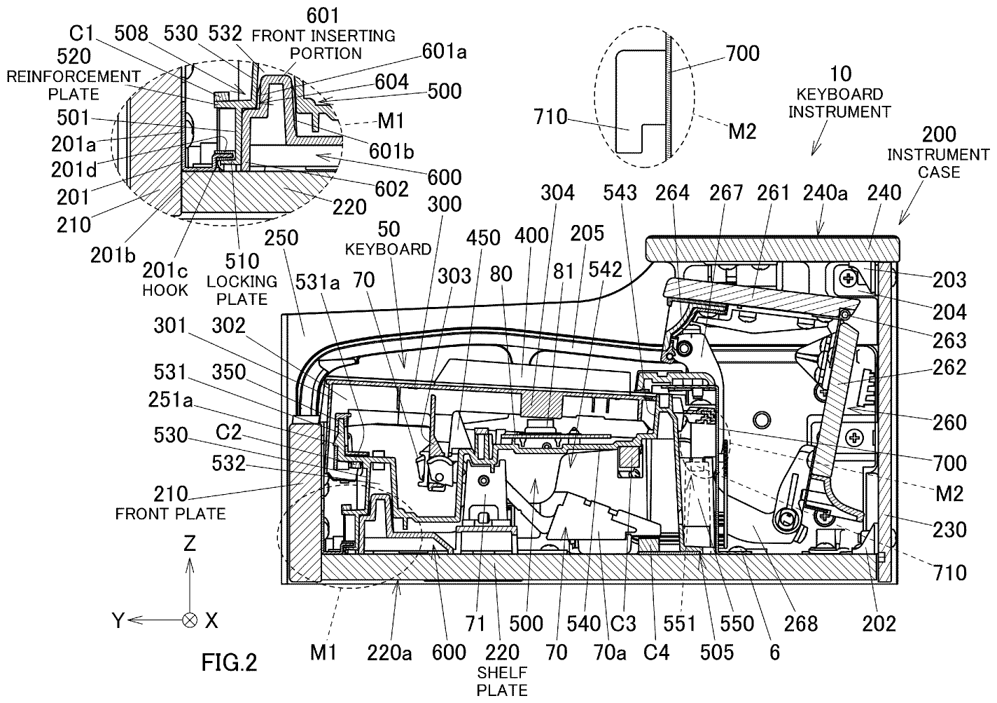

As shown in FIG. 2, the instrument case 200 of the keyboard instrument 10 includes the front plate 210, which is long in the key alignment direction LR and has a plate shape, on the front side F of the multiple keys (the white keys 300, the black keys 400). A shelf plate 220 is provided at a bottom portion of the instrument case 200, and this shelf plate 220 constitutes a lower surface 220a of the instrument case 200. The front plate 210 and the shelf plate 220 are connected together with a front connector unit 201, which is a substantially L-shaped connector unit in a side view.

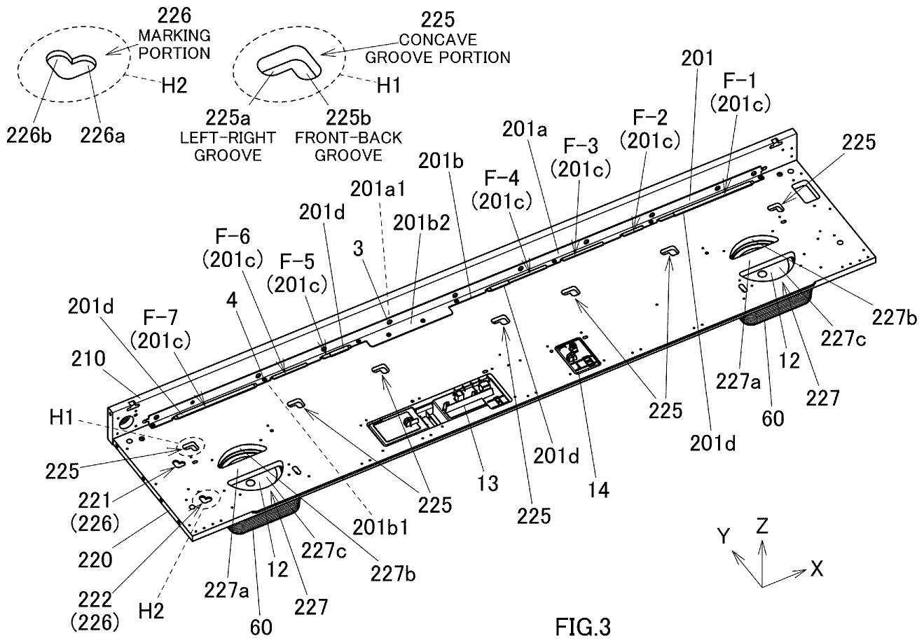

The front connector unit 201 has a vertical plate 201a, a plate surface of which is oriented in the front-back direction FB and a horizontal plate 201b, a plate surface of which is oriented in the upper-lower direction UL. As shown in FIG. 3, the vertical plate 201a has multiple screw holes 201a1 provided therein. The vertical plate 201a is fixed to the front plate 210 via the screw holes 201a1 with screw elements 3. The horizontal plate 201b is fixed to the shelf plate 220 via multiple screw holes 201bs with screw elements 4.

A broad portion 201b2, which broadens in the front-back direction FB, is provided on the horizontal plate 201b substantially at a central portion thereof. Additionally, multiple hooks 201c are provided on the horizontal plate 201b. As shown in an enlarged view of an encircled portion denoted by M1 in FIG. 2, the hook 201c is provided in such a manner as to extend from the horizontal plate 201b into a crank shape in a side view to protrude towards the back side B in a longitudinal direction (the front-back direction FB) of the key and moves away from an upper surface of the shelf plate 220. As show in FIG. 3, seven hook portions F-1 to F-7 constituting the hook 201c are disposed on the horizontal plate 201b in the manner described above while lengths thereof in the key alignment direction LR are made different. The hook portions F-1, F-7, which are provided at left and right end portions of the horizontal plate 201b, respectively, are provided longer than the other hook portions F-2 to F-6. A deflection amount is increased at left and right end portions of the instrument case 200, and to cope with this tendency, the hooks 201c are provided longer at those portions to suppress the deflection of the instrument case 200.

An elastic element 201d in the form a sheet is provided on the hook portion F-1 positioned at the end portion on the left side L, the hook portion F-4 positioned at a central portion closer to the left side L, the hook portion F-5 positioned at a central portion closer to the right side R, and the hook portion F-7 positioned at the end portion on the right side R in such a manner as to wind around the hook 201c thereof (refer to the enlarged view of the encircled portion M1 in FIG. 2). The elastic elements 201d provided on the hook portion F-1 and the hook portion F-7 are provided longer than the elastic elements 201d on the hook portion F-4 and the hook portion F-5 to match the lengths of the hooks 201c thereof. The elastic element 201d can be made of a felt material or a non-woven. A dimensional tolerance at left and right end portions of a keyboard chassis 500 and the front connector unit 201 where a deflection is easy to occur in production can be absorbed more by providing the elastic element 201d on the instrument case 200 in positions closer to the left side L and the right side R in the key alignment direction LR than providing at the center.

Multiple back lower connector units 202 are provided in the vicinity of a back end edge of the shelf plate 220. On the other hand, an upper surface plate 240, constituting an upper surface 240a of the instrument case 200, is provided at the back side B of the multiple keys (the white keys 300, the black keys 400). Multiple back upper connector units 203 are provided in the vicinity of a rear end edge of the upper surface plate 240. The back lower connector units 202 and the back upper connector units 203 have screw holes provided therein in such a manner as to penetrate in the upper-lower direction UL and the front-back direction FB and are provided substantially into an L shape. The back lower connector units 202 are screwed down to the shelf plate 220 from the upper side Up, and the back upper connector units 203 are screwed to the upper surface plate 240 from the lower side Lo. The instrument case 200 includes a back plate 230, and this back plate 230 is fixed to the instrument case 200 with screw elements via the screw holes provided in the back lower connector units 202 and the back upper connector units 203 in such a manner as to penetrate in the front-back direction FB. The back plate 230 is screwed down to be fixed to the back lower connector units 202 and the back upper connector units 203 from an outer surface thereof.

The instrument case 200 includes the left and right side plates 250. The left and right side plates 250 are connected to the back plate 230 with a left back connector unit 204 and a right back connector unit (not shown), which are each made of a substantially L-shaped sheet metal unit. In addition, a support panel 205 is provided in the vicinity of left and right end edges of the shelf plate 220. The left and right support plates 205 are screwed down to be fixed to the shelf plate 220. Then, the left and right side plates 250 are fixedly screwed down to the left and right support panels 205, respectively.

The instrument case 200 has a keyboard lid 260, and this keyboard lid 260 is configured to be folded into two and constitutes a lid of the multiple keys (the white keys 300, the black keys 400). The keyboard lid 260 is made up of a front lid plate 261 and a back lid plate 262 which are two plate-shaped elements elongated in the key alignment direction LR, and these front lid plate 261 and back lid plate 262 are connected together by a hinge 263. A front lid plate link element 267 and a back lid plate link element 268 are provided rotatably on each of the left and right support panels 205. The front lid plate 261 is connected rotatably to the front lid plate link elements 267 via a drawer unit 264, which is provided at a front end edge of the front lid plate 261 and is elongated in the key alignment direction LR. Similarly, the back lid plate 262 is connected rotatably to the back lid plate link elements 268. The keyboard lid 260 is folded as a result of the front lid plate 261 and the back lid plate 262 being folded along the key alignment direction LR as a dividing line and is accommodated in an interior of the instrument case 200 defined below the upper surface plate 240 when the keyboard lid 260 is accommodated. The keyboard lid 260 can cover the multiple keys (the white keys 300, the black keys 400) when the keyboard lid 260 is pulled out towards the front side F by hooking the finger or fingers in a concave portion in the drawer unit 264.

A keyboard 50, which supports the multiple keys (the white keys 300, the black keys 400), is provided in the interior of the instrument case 200. The keyboard 50 includes the multiple keys (the white keys 300, the black keys 400), the keyboard chassis 500, and a mount 600 provided in an interior of the keyboard chassis 500. As shown in FIGS. 2, 4 and 5, the keyboard chassis 500 is provided long in the key alignment direction LR and substantially into a crank shape in a side view. A space is provided in the interior of the keyboard chassis 500. A locking plate 510 (a locking unit) and a reinforcement plate 520 are provided on a lower side Lo and an upper side Up, respectively, of a front surface plate 501 provided at a front side F of the keyboard chassis 500.

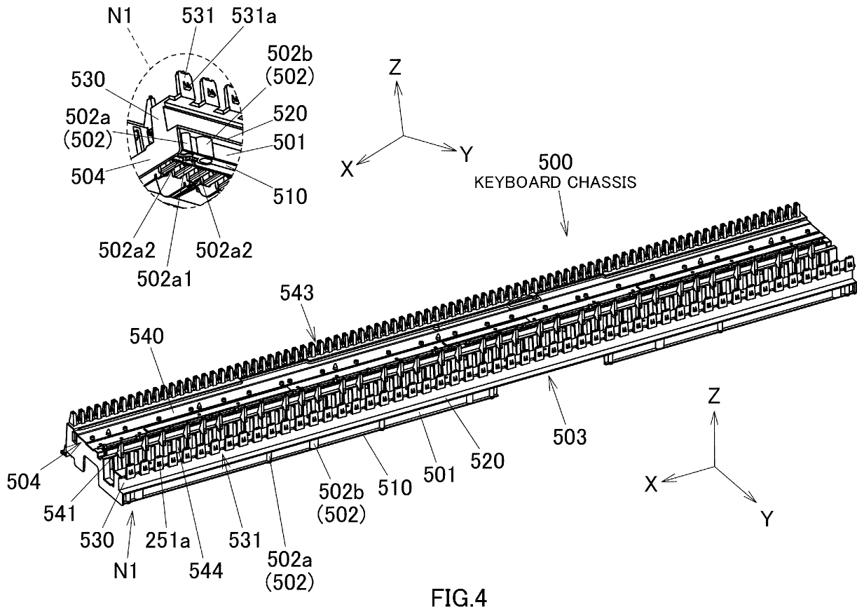

The front surface plate 501, the locking plate 510, and the reinforcement plate 520 are formed long in the key alignment direction LR into a plate shape. Here, the front surface plate 501 and the locking plate 510 are discontinued partially along the full length thereof by a discontinued portion 503. This discontinued portion 503 corresponds to the broad portion 201b2 of the front connector unit 201. In addition, as shown in FIG. 4, pillar portions 502 are provided on the keyboard chassis 500 to support an interspace between the locking plate 510 and the reinforcement plate 520. As shown in an enlarged view of a portion denoted by Ni as viewed from a direction Ni in FIG. 4 (a direction in which the keyboard chassis 500 is viewed from a lower side towards an upper side thereof), the pillar portion 502 includes a substantially cylindrical pillar portion 502a and a pillar portion 502b having an angularly rounded rectangular cylindrical shape. The substantially cylindrical pillar portion 502a includes a shelf plate abutment portion 502a1 (an abutment protrusion) which protrudes downwards via the locking plate 510 and two ribs 502a2 which extend from the shelf plate abutment portion 502a1 in an opposite direction to the key alignment direction LR. In other words, the abutment protrusion including the shelf plate abutment portion 502a1 and the ribs 502a2 protrudes from the locking plate 510 towards the shelf plate 220.

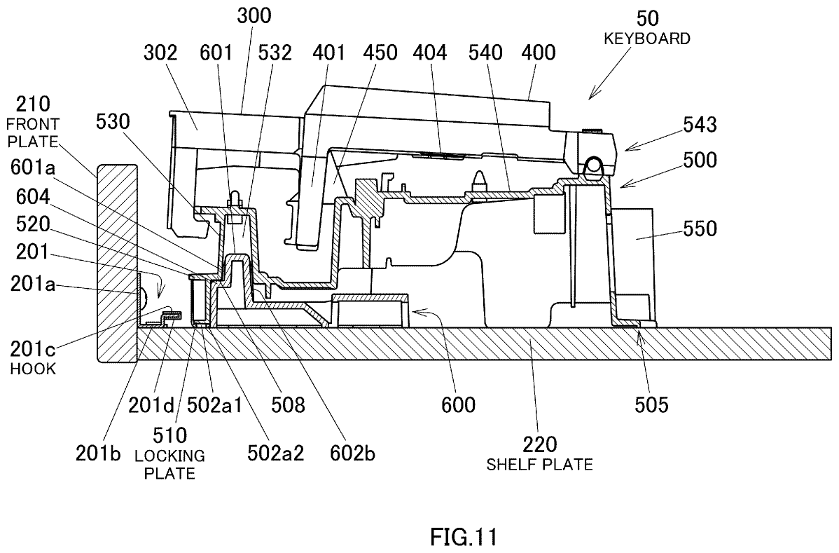

Lower surfaces of the shelf plate abutment portion 502a1 and the ribs 502a2 are made substantially level with lower surfaces of side surface plates 504 of the keyboard chassis 500 which are brought into abutment with an upper surface of the shelf plate 220 and a back abutment surface 505 (refer to FIG. 2) of the backside of the keyboard chassis 500. As a result, in such a state that the keyboard chassis 500 is assembled in the instrument case 200, the upper surface of the shelf plate 220 is brought into abutment with the lower surfaces of the shelf plate abutment portion 502a1 and the ribs 502a2 on a front side F of the keyboard chassis 500. Then, the locking plate 510 is disposed in such a manner as to be spaced apart from the upper surface of the shelf plate 220 (also, referred to FIG. 11).

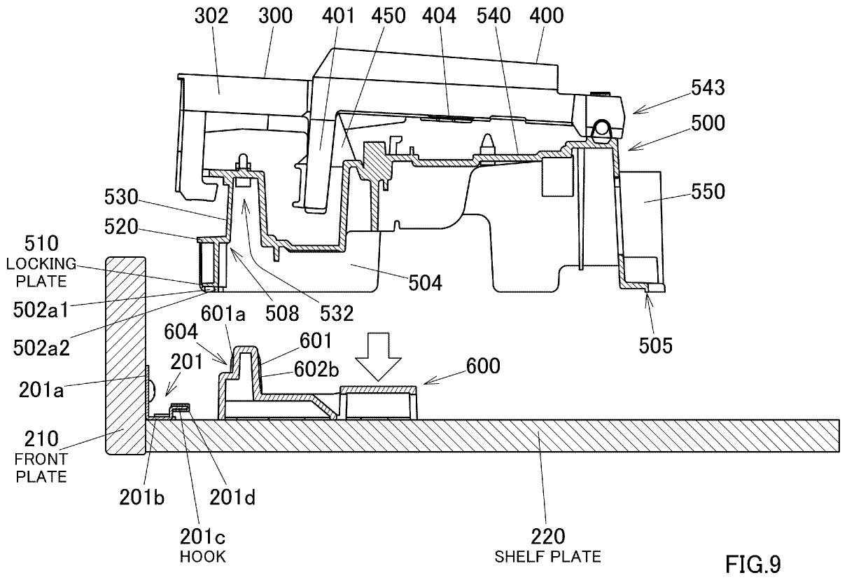

A front insertion target portion 530 (a first insertion target portion) is provided on the keyboard chassis 500 on a back side B of the reinforcement plate 520. As seen in the cross-sectional view from the side in FIG. 2, the front insertion target portion 530 is provided long in the key alignment direction LR as having a substantially U-shaped section an open side of which is oriented towards the lower side Lo (refer to FIG. 4). A tapering inner space 532 is provided in an interior of the front insertion target portion 530 having the substantially U-shaped section (also, referred to FIG. 9), and this tapering inner space 532 tapers gradually in a width in the front-back direction FB as it extends towards the upper side Up. A plate-shaped rubber support portion 531, configured to support a slidable rubber 350 (refer to FIG. 2) provided in such a manner as to correspond to each white key 300, is provided on an upper side Up of the front insertion target portion 530 in such a manner as to be erected from a front side F of the front insertion target portion 530 with plate surfaces thereof oriented in the front-back direction FB. An engagement protrusion 251a (refer to FIG. 2), which is configured to be brought into engagement with a hole in the slidable rubber 350, is provided on a front surface of the rubber support portion 531.

A support table 540 is provided on the back side B of the keyboard chassis 500 in such a manner as to extend long in the key alignment direction LR, and this support table 540 has a substantially U-shaped section an open side of which is oriented towards the lower side Lo in a side view. A hammer 70, which is configured to be supported on the mount 600, which will be later, is accommodated in an inner space 542 of the support table 540. Here, as shown in FIG. 4, multiple openings 544 (refer to FIG. 4) are provided in a front side F of the support table 540 so that front ends of the hammers 70 protrude from the inner space 542 or an interior of the support table 540. Multiple rubber support portions 541 (refer to FIG. 4) are provided on the front side F of the support table 540 in such a manner as to protrude towards the upper side Up so as to support corresponding slidable rubbers 450 (refer to FIG. 2) which are provided in such a manner as to correspond individually to the black keys 400.

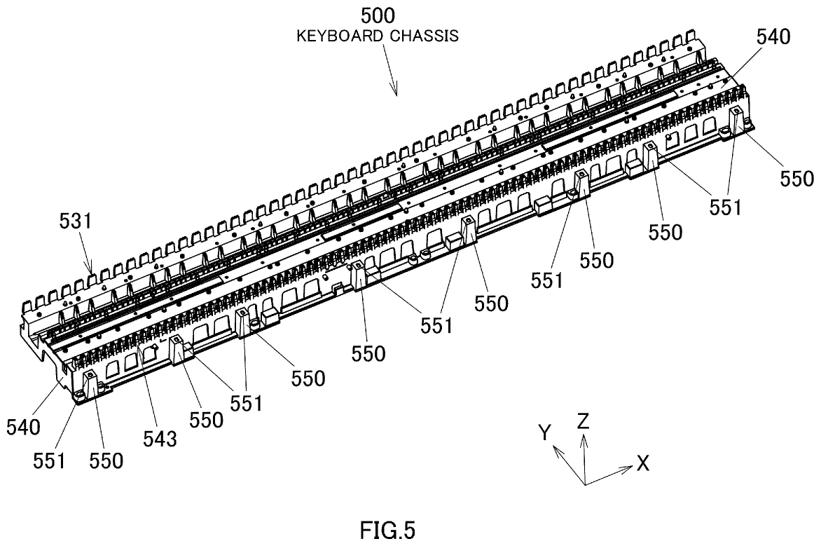

As shown in FIG. 2, a circuit board 80 including a switch 81 provided thereon is disposed on an upper surface of the support table 540. Key support portions 543 are provided on a back edge of the support table 540 for supporting rotatably the white keys 300 and the black keys 400 (also, referred to FIGS. 4 and 5). In addition, as shown in FIG. 5, multiple back insertion target portions 550 (second insertion target portions), each having substantially a frustum of quadrangular pyramid, are provided on a back side B of the support table 540. An inner space is provided in the back insertion target portion 550. A circular opening hole 551 is provide in an upper surface portion in such a manner as to communicate with the inner space of the back insertion target portion 550.

The multiple keys (the white keys 300, the black keys 400) are supported rotatably by the keyboard chassis 500. The white keys 300 are individually supported rotatably at back ends thereof by the key support portions 43 of the keyboard chassis 500. The white key 300 has a front plate 301 which extends towards the lower side Lo from a front side F of an upper surface plate thereof which constitutes a key press-down surface. The white key 300 includes left and right side plates 302. The left and right side plates 302 each extend towards the lower side Lo into a hook shape on a front side F thereof in such a manner as to hold the front plate 301 therebetween. The left and side plates 302 each extending into the hook shape are guided by the slidable rubber 350 provided between the left and right side plates 302. In addition, a hammer pressing portion 303 is provided on the white key 300 in such a manner as to be connected with the hammer 70. A switch pressing portion 304 is provided on the white key 300 in such a manner as to protrude towards the lower side Lo to thereby press down the switch 81 provided in such a manner as to correspond to each white key 300.

When the white key 300 is pressed down, lower ends of the left and right hook-shaped side plates 302 descend until the lower ends are brought into abutment with a cushion C1 provided on an upper surface of the reinforcement plate 520. As this occurs, a weight element 70a at the back of the hammer 70 rises to be brought into abutment with a cushion C3 provided on a lower surface of the support table 540. When the finger is released from the white key 300, the weight element 70a descends to be brought into abutment with a cushion C4 provided on the shelf plate 220. As this occurs, jaw portions of the left and right side plates 302 of the white key 300 are brought into abutment with a cushion C2 provided on a lower surface of a support plate 531a below the rubber support portion 531 which protrudes towards the front side F.

The black key 400 and the white key 300 have similar structures. That is, referring also to FIGS. 2 and 9, the black key 400 is supported rotatably by the key support portion 543 of the keyboard chassis 500 at a back end thereof. The black key 400 has a front plate element 401 having side plates, and the front plate element 401 is guided by the slidable rubber 450. In addition, the front plate element 401 is connected to the hammer 70. A switch pressing portion 404 is provided on the black key 400 in such a manner as to press down the switch 81 provided corresponding to each black key 400.

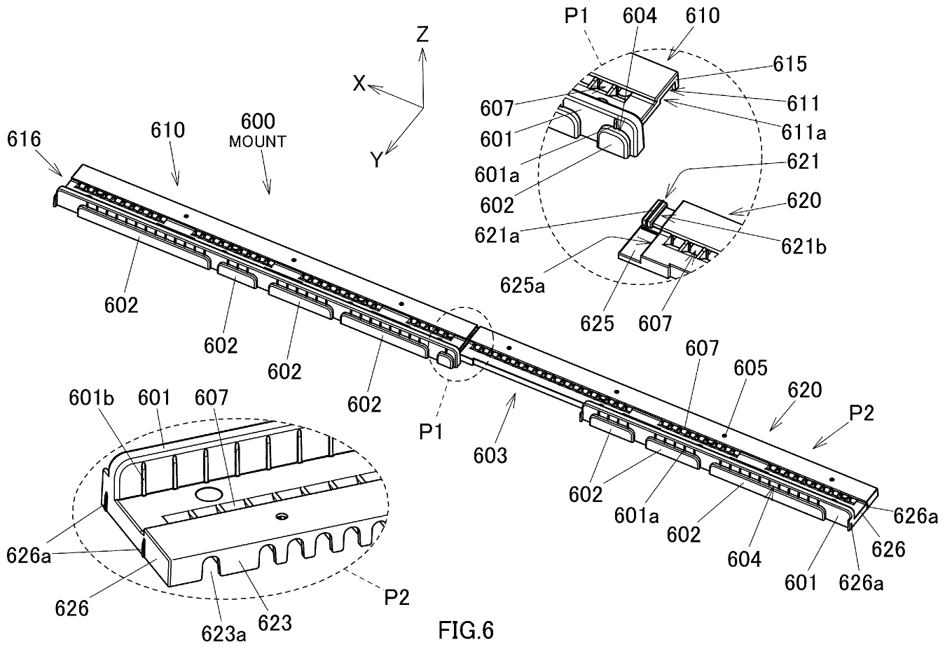

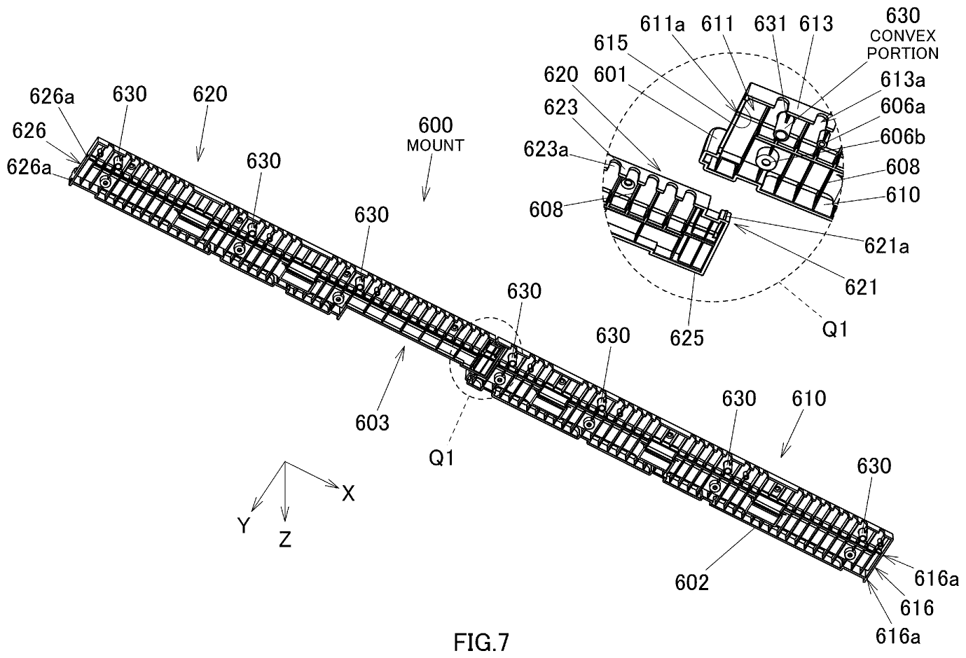

As shown in FIGS. 6 and 7, the mount 600 is provided in such a manner as to be divided into two, that is, a left mount unit 610 and a right mount unit 620. A front inserting portion 601 (a first inserting portion) is provided on a front side F of the mount 600 in such a manner as to protrude substantially into an angle shape in a side view. The front inserting portion 601 is formed long in the key alignment direction LR and includes a discontinued portion 603 substantially at a central portion thereof. This discontinued portion 603 corresponds to the broad portion 201b2 in the front connector unit 201 and the discontinued portion 503 in the keyboard chassis 500. The front inserting portion 601, including multiple protrusions 601a, 601b, which will be described later, is provided into a tapering shape which narrows (in a width in the front-back direction FB) as it extends towards the upper side Up in a side view.

Multiple protruding portions 602 are provided on a front side F of the first inserting portion 601. The protruding portion 602 is formed substantially into a plate, plate surfaces of which are oriented to face the front-back direction FB, and two upper corner portions of the protruding portion 602 are angularly rounded. Then, the protruding portion 602 protrudes towards the front side F. Lengths in the key alignment direction LR of the multiple protruding portions 602 are made different. The protruding portion 602 is made level with the front inserting portion 601 along a lower side thereof but is made lower than the front inserting portion 601 at an upper side thereof. As a result, a step portion 604 is provided at a connecting portion between the protruding portion 602 and the front inserting portion 601. Multiple protrusions 601a are provided on a front surface of the front inserting portion 601 at the step portion 604, while multiple protrusions 601b are provided on a back surface of the front inserting portion 601.

The mount 600 is made thicker in a thickness in the upper-lower direction UL on a back side B thereof, and multiple screw holes 605 are provided in an upper surface of the mount 600, so that a hammer support unit 71 (refer to FIG. 2) on which the hammer 70 is placed is attached to the upper surface of the mount 600 via those multiple screw holes 605. Multiple openings 607 are provided in the key alignment direction LR in an interspace defined between the front inserting portion 601 and the portion where the screw holes 605 are provided.

As shown in an enlarged view of an encircled portion denoted by P1 in FIG. 6 and an enlarged view of an encircled portion denoted by Q1 in FIG. 7, the left mount unit 610 and the right mount unit 620 are connected integrally to each other by a concave-convex engagement made between a connecting concave portion 611 provided at a right end of the left mount unit 610 and a connecting convex portion 621 provided at a left end of the right mount unit 620. The connecting convex portion 621 is provided substantially into a strip shape of a predetermined width having a U-shaped section in which an open side is oriented downwards on a back side B of a connecting plate 625 which protrudes from the left end of the right mount unit 620 into the shape of a tongue piece. A protrusion 621a is provided on the connecting convex portion 621 in such a manner as to protrude along an outer surface of the connecting convex portion 621. On the other hand, a step portion 611a is provided on a front side F of the connecting concave portion 611.

When the connecting convex portion 621 is inserted into the connecting concave portion 611, a front side F of the connecting convex portion 621 faces the step portion 611a, and a back side B of the connecting convex portion 621 faces a back surface plate 613 of the left mount unit 610, whereby a relative front-back movement of the left mount unit 610 and the right mount unit 620 is restricted. Additionally, an edge surface 621b on a right side R of the connecting convex portion 621 of the right mount unit 620 faces a right edge portion 615 of the left mount unit 610. Then, a left side surface 625a at a base portion of the connecting plate 625 of the right mount unit 620 faces the right edge portion 615 of the left mount unit 610. As a result, a relative movement of the left mount unit 610 and the right mount unit 620 in the left-right direction is restricted.

As shown in FIG. 7, multiple convex portions 630, which are individually erected towards the lower side Lo, are provided on the mount 600 (the left mount unit 610, the right mount unit 620). The multiple convex portions 630 are provided at predetermined intervals in the key alignment direction LR. In the present embodiment, four convex portions 630 are provided on the left mount unit 610, while three convex portions 630 are provided on the right mount unit 620. The convex portions 630 are individually provided substantially into a cylindrical shape. Multiple ribs 631 are provided on an outer circumference of the convex portion 630 for reinforcement.

An outside diameter of the convex portion 630 is set slightly smaller than a groove width of a concave groove portion 225, which will be described later, formed in the shelf plate 220. Thus, the convex portion 630 is brought into concave-convex engagement with the concave groove portion 225. In other words, a concave-convex engagement structure is provided between the convex portion 630 and the concave groove portion 225. The multiple convex portions 630 are individually brought into concave-convex engagement with multiple concave groove portions 225 corresponding thereto.

Multiple ribs 608 and multiple bosses 606a, 606b are provided on a surface of the mount 600 which lies on a lower side Lo thereof in such a manner as to correspond individually to the openings 607. Multiple opening holes 613a, 623a, which are opened substantially into a U shape, are provided in a back surface plate 613 of the left mount unit 610 and a back surface plate 623 of the right mount unit 620 in positions corresponding to interspaces defined between any pair of ribs 608 of the multiple ribs 608.

As shown in FIG. 3, the multiple concave grooves 225 are provided in an upper surface of the shelf plate 220. In the present embodiment, seven concave groove portions 225 are provided at predetermined intervals in the key alignment direction LR. The concave groove portion 225 includes a left-right groove 225a which is long in the key alignment direction LR and a front-back groove 225b which communicates with the left-right groove 225a and which is long in the front-back direction FB. In the concave groove portion 225, the left-right groove 225a is provided on the front side F, and the concave groove portion 225 is made substantially into an L shape in a plan view.

In addition, two marking portions 226 are provided in the vicinity of an end portion of the shelf plate 220 on the right side R with a predetermined interval defined therebetween in the front-back direction FB. Of the two marking portions 226, a first marking portion 221 is provided on the front side F, while a second marking portion 222 is provided on the back side B. The marking portion 226 includes a left-right marking groove 226a which is long in the key alignment direction LR and a front-back groove 226b which communicates with the left-right marking groove 226a and which is long in the front-back direction FB. In the marking portion 226, the left-right marking groove 226b is provided on the back side B, and the marking portion 226 is formed substantially into an L shape in a plan view.

A groove width of the concave groove portion 225 and a groove width of the marking portion 226 are made substantially the same. As a result, in machining a shelf plate 220, a concave groove portion 225 and a marking portion 226 can be machined in a material of a shelf plate 220 which is set in a numerically controlled working machine without changing machining tools. Here, lengths of the left-right groove 225a and the front-back groove 225b of the concave groove portion 225 are made shorter than lengths of the left-right marking groove 226a and the front-back marking groove 226b of the marking portion 226. In addition, the concave groove portion 225 and the marking portion 226 have substantially the L shapes which are rotated 180 degrees relative to each other.

As shown in FIG. 2, the keyboard instrument 10 includes a back fixing unit 700 (a fixing unit) which is provided on the back side B of the keyboard chassis 500. The back fixing unit 700 is made of a sheet metal material and is formed substantially into a crank shape in a side view. A screw hole is provided in a lower end portion of the back fixing unit 700 which protrudes towards the back side B in such a manner that a screw element 6 is passed therethrough, so that the back fixing unit 700 is fixed to the shelf plate 220. The back fixing unit 700 has a back inserting portion 710 (a second inserting portion) which is provided on a font side F thereof in such a manner as to protrude towards the lower side Lo with plate surfaces thereof oriented in the key alignment direction LR. The back inserting portion 710 is inserted in the opening hole 551 in the back insertion target portion 550 of the keyboard chassis 500.

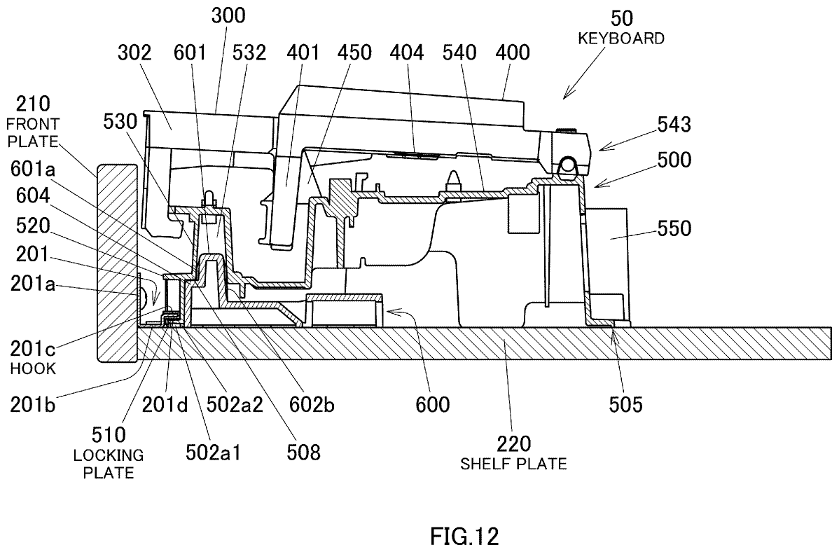

With the back fixing unit 700 which is provided to extend a predetermined length in the key alignment direction LR, three back fixing units 700 are disposed on the back side B of the keyboard chassis 500, as shown in FIG. 12.

A fabricating method of the keyboard instrument 10 will be described in which the keyboard 50 is assembled in the instrument case 200.

Here, the concave-convex engagement structure includes the concave groove portion 225 which is provided in either (in the embodiment, the shelf plate 220) of the keyboard 50 and the shelf plate 220 and the convex portion 630 which is provided in the other (in the present embodiment, the mount 600 of the keyboard 50). The concave groove portion 225 and the convex portion 630 constitute the concave-convex engagement in which the concave groove portion 225 and the convex portion 630 can be brought into engagement with each other. Here, a concave-convex engagement structure may be adopted in which a concave groove portion is provided in the keyboard 50, while a convex portion is provided in the shelf plate 220. The fabricating method of the keyboard instrument 10 has a front-back groove engagement step of bringing the convex portion 630 into engagement with the front-back groove 225b of the concave groove portion 225 and a left-right groove engagement step of moving the convex portion 630 towards the front side F so as to bring the convex portion 630 into engagement with the left-right groove 225a.

In the front-back groove engagement step, when the convex portions 630 are moved to the front side F, the locking plate 510 of the keyboard chassis 500 is inserted between the hooks 201c of the front connector unit 201 and the shelf plate 220. To describe this in detail, the front-back groove engagement step includes (1) a step of disposing the mount 600 in the instrument case 200 in alignment with the first marking portion 221 provided on the instrument case 200, (2) a step of disposing the keyboard chassis 500 in alignment with the second marking portion 222 provided on the instrument case 200 to dispose the keyboard chassis 500 on the upper side Up of the mount 600, and (3) a keyboard insertion step of inserting the locking plate 510 constituting a part of the keyboard 50 into a gap defined between the hooks 201c of the front connector unit 201 provided in the instrument case 200 and the shelf plate 220 of the instrument case 200 by sliding the keyboard 50 on the shelf plate 220.

Subsequently, in the left-right groove engagement step, when the convex portions 630 are moved in the left-right direction (the key alignment direction LR, in the present embodiment, to the right side R), the keyboard 50 is disposed in the regular position with respect to the shelf plate 220.

Further, the fabricating method of the keyboard instrument 10 includes after the front-back groove engagement step and the left-right groove engagement step a keyboard fixing step of rotating a rotational unit 800, which is provided at at least one end of the keyboard 50 in the key alignment direction LR, to thereby fix the keyboard 50 to the instrument case 200.

The mount 600 is placed on the shelf plate 220 as a result of the front-back groove engagement step, and the left-right groove engagement step is performed after the keyboard chassis 500 is placed on the mount 600. The mount 600 is disposed in alignment with the first marking portion 221 on the shelf plate 220. As a result, the front-back groove engagement step is performed. That is, the convex portion 630 and the front-back groove 225b of the concave groove portion 225 are brought into engagement with each other. Then, the keyboard chassis 500 is disposed on the shelf plate 220 in alignment with the second marking portion 222. Then, the front inserting portion 601 of the mount 600 is inserted to be fitted in the inner space of the front insertion target portion 530 of the keyboard chassis 500, whereby the mount 600 is disposed inside the keyboard chassis 500.

The back fixing units 700 are assembled to the shelf plate 220 on the back side B of the keyboard chassis 500. As this occurs, the back inserting portion 710 of the back fixing unit 700 is inserted into the opening hole 551 of the back insertion target portion 550.

After the left-right groove engagement step is completed and the keyboard 50 is disposed in the regular attachment position with respect to the shelf plate 220, the keyboard fixing step is performed in which the rotational unit 800 is brought into abutment with the keyboard chassis 500 of the keyboard 50 by rotating the rotational unit 800 by rotating a screw element 880 so that the instrument case 200 and the keyboard 50 are fixed together.

Thereafter, the other constituent components (the back plate 230, the upper surface plate 240, the left and right side plates 250) of the instrument case 200, the keyboard lid 260, the left wing 206, the right wing 207, the left and right support panels 205, and electrical components are provided, whereby the keyboard instrument 10 is completed. The keyboard instrument 10 is attached to the instrument stand 20 after the keyboard instrument 10 is completed in the way described above.

The fabricating method (assembling method) of the keyboard instrument 10 will be described further specifically.

Fist of all, the front plate 210 and the shelf plate 220 are connected to each other with the front connector unit 201. Here, as shown in FIG. 3, components (for example, loudspeakers 12, connector cases 13, 14, and the like) which are to be attached to the shelf plate 220 from a lower surface side of the shelf plate 220 can be attached to the shelf plate 220 before or after the front plate 210 and the shelf plate 220 are connected together with the front connector unit 201. Here, a sound emitting hole 227 is provided in the shelf plate 220 in a position corresponding to a loudspeaker 12. A beam 227a is provided in such a manner as to span a circular opening of the sound emitting hole 227, and hence, the sound emitting hole 227 is made up of a front semi-circular hole 227b on the front side F and a back semi-circular hole 227c on the back side B.

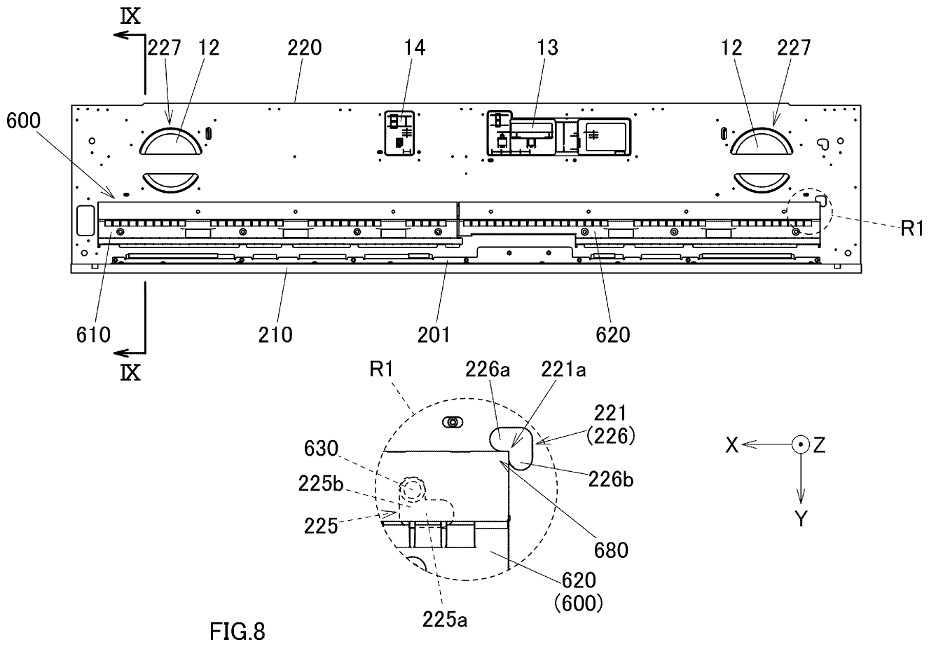

Then, the assembler assembles the mount 60 to the shelf plate 220 which is connected with the front plate 210. As shown in an enlarged view of an encircled portion denoted by R1 in FIG. 8, the mount 600 is placed to be disposed on the shelf plate 220 by disposing a right back corner portion 680 of the mount 600 in alignment with a corner portion inside the substantially L shape of the first marking portion 221 (an inner corner portion 221a). Then, the individual convex portions 630 of the mount 60 are brought into concave-convex engagement with the corresponding concave groove portions 225. Each convex portion 630 is disposed at a back end of the front-back groove 225b of the concave groove portion 225.

In the mount 600, the left mount unit 610 and the right mount unit 620 are connected together in advance. Then, the hammer support unit 71 and the hammers 70 are attached to the mount 600 after the mount 600 is disposed on the shelf plate 220.

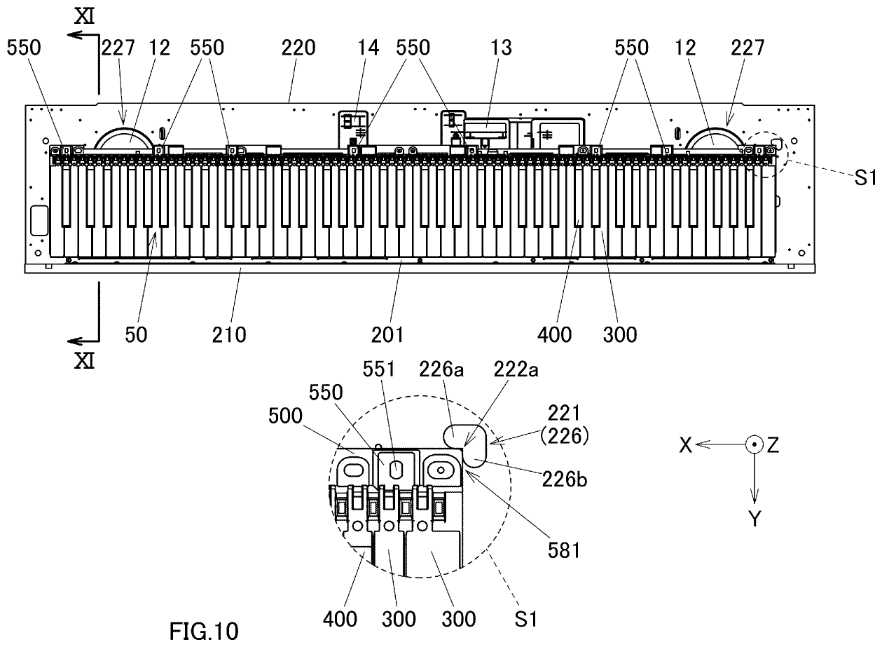

Next, as shown in FIG. 9, the keyboard chassis 500 on which the multiple keys (the white keys 300, the black keys 400), the base plate 80, and the like are attached is placed to be disposed in such a manner as to cover the mount 600. As shown in an enlarged view of an encircled portion denoted by Si in FIG. 10, a right back corner portion 581 of the keyboard chassis 500 is disposed in alignment with a corner portion inside the substantially L shape of the second marking portion 222 (an inner corner portion 222a). Then, the front inserting portion 601 of the mount 600 shown in FIG. 9 is inserted into the inner space 532 of the front insertion target portion 530 of the keyboard chassis 500, as shown in FIG. 11. As this occurs, the lower surface of the shelf plate abutment portion 502a1, the lower surface of the rib 502a2 which is level with the lower surface of the shelf plate abutment portion 502a1, and the respective lower surfaces of the side surface plates 504 of the keyboard chassis 500 are brought into abutment with the upper surface of the shelf plate 220.

When the front inserting portion 601 is inserted into the inner space 532 of the front insertion target portion 530, the step portion 604 (an upper surface of the protruding portion 602) of the mount 600 and the step portion 508 (the lower surface of the reinforcement plate 520) defined between the front insertion target portion 530 and the reinforcement plate 520 of the keyboard chassis 500 are brought into abutment with each other. In this way, the keyboard chassis 500 and the mount 600 are fitted together. Then, the protrusions 601a on the front side F of the mount 600 come close to or into contact with an inner surface (a front surface of the inner space 532) of the front insertion target portion 530. Then, the protrusions 602b on the back side B of the mount 600 come close to or into contact with an inner surface (a back surface of the inner space) of the front insertion target portion 530. In this way, a relative movement in the front-back direction FB of the keyboard chassis 500 and the mount 600 is restricted.

As shown in an enlarged view of an encircled portion denoted by P2 in FIG. 6, two protrusions 626a, which extend long in the upper-lower direction UL, are provided on a right side surface 626 of the right mount unit 620 of the mount 600. Similarly, protrusions 616a are provided on a left side surface 616 of the left mount unit 610 (refer to FIG. 7). The protrusions 616a, 626a come close to or into contact with inner surfaces of the left and right side surface plates 504 of the keyboard chassis 500, whereby a relative movement in the key alignment direction of the mount 600 to the keyboard chassis 500 is restricted.

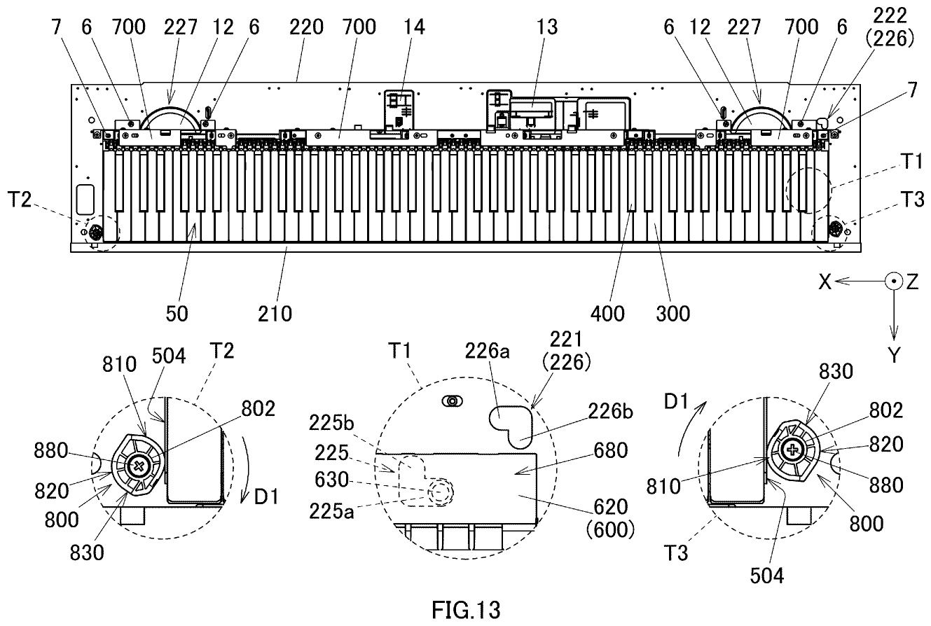

The hammers 70 are connected individually with the corresponding white keys 300 and the corresponding black keys 400 after the keyboard chassis 500 on which the multiple keys (the white keys 300, the black keys 400) and the like are provided is disposed on the mount 600. The keyboard 50 in which the keyboard chassis 500 is disposed on the mount 600 is moved to the front side F, and as shown in FIG. 12, the locking plate 510 is inserted between the hook 201c and the upper surface of the shelf plate 220, that is, into a gap defined between the hook 201c (the front connector unit 201) and the shelf plate 220. When the keyboard 50 is moved to the front side F, the convex portion 630 is moved to the front side F along the front-back groove 225b of the concave groove portion 225 (refer to the enlarged view of the encircled portion denoted by R1 in FIG. 8 and an enlarged view of an encircled portion denoted by T1 in FIG. 13).

When the convex portion 630 is moved to the front side F along the front-back groove 225b of the concave groove portion 225 and then the convex portion 630 arrives at an intersection point between the left-right groove 225a and the front-back groove 225b, the convex portion 630 is then moved to the right side R along the left-right groove 225a. As shown in the enlarged view of the encircled portion denoted by T1 in FIG. 13, when the movement of the keyboard 50 is completed, the convex portion 630 is positioned substantially at a right end portion of the left-right groove 225a. As a result, the keyboard 50 (the keyboard chassis 500 and the mount 600) is fixed so as not to move in at least front-back direction FB relative to the shelf plate 220.

That is, when the convex portion 630 arrives at the intersection point between the left-right groove 225a and the front-back groove 225b, the locking plate 510 of the keyboard 50 (the keyboard chassis 500) is disposed between the hook 201c and the upper surface of the shelf plate 220. Then, when the convex portion 630 moves into the left-right groove 225a, the locking plate 510 moves while sliding between the hook 201c and the shelf plate 220. In this way, the front side F of the keyboard chassis 500 is fixed so as not to move in the upper-lower direction UL as a result of the locking plate 510 being disposed between the hook 201c and the shelf plate 220. The keyboard 50 is fixed to the instrument case 200 in such a state that the locking plate 510 is disposed between the hook 201c and the shelf plate 220.

Here, in the present embodiment, the concave groove portion 225 is provided in such a manner that the convex portion 630 is moved to the front side F and is then moved to the right side R, however, another configuration can also be adopted. For example, the convex portion 630 can also be configured to be moved to the back side B and then to be moved to the left side L by providing the hooks 201c and the locking plate 510 on the back side B. In the present embodiment, a gap defined by the white key 300 lying adjacent to the right wing 207 can be made extremely close to a designed value by positioning the keyboard 50 by moving the convex portion 630 to the right side R finally. The player tends to look at the right side R more than the left side L due to the volume control knob 208 and the push-button switch 209 being provided on the right side R of the keyboard instrument 10, and hence, the aesthetic appearance imparted to the player can be enhanced more.

In the present embodiment, the hooks 201c are provided on the front side F of the keyboard instrument 10, and the convex portions 630 of the mount 600 are fitted individually in the corresponding front-back grooves 225b from the back side B, whereby the convex portions 630 of the mount 600 are moved from the back side B to the front side F. As a result, a space on the front side F of the keyboard instrument 10 which lies close to the player is adjusted to be small, resulting in an advantage that the keyboard instrument 10 with a good appearance can be provided.

As shown in FIG. 13, the back fixing units 700 are attached after the keyboard 50 is disposed in the regular position. To attach the back fixing unit 700, the screw holes in the lower end of the back fixing unit 700 are aligned with internally threaded portions in the shelf plate 220 while inserting the back inserting portion 710 shown in the enlarged view of the encircled portion denoted by M2 in FIG. 2 into the opening hole 551 in the back insertion target portion 550 of the keyboard chassis 500, and the back fixing unit 700 is fixed to the shelf plate 220 with the screw elements 6. As shown in the enlarged view of the encircled portion denoted by M2 in FIG. 2, the back inserting portion 710 is provided in such a manner as to protrude downwards so as to enter the opening hole 551. As a result, the back side B of the keyboard chassis 500 is fixed so as not to be moved in the upper-lower direction UL.

The back fixing units 700 and the keyboard chassis 500 are fixed to each other with the screw elements 7 at the left and right end portions and the like on the back side B of the keyboard chassis 500.

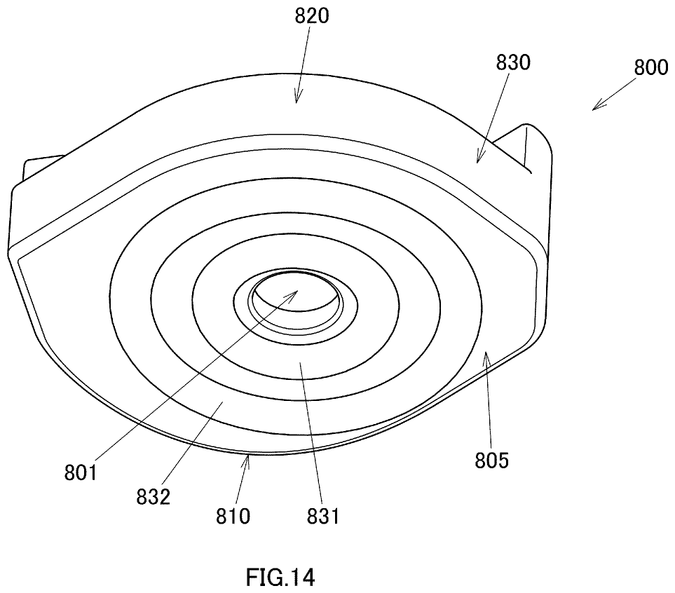

After the back fixing units 700 are attached accordingly, as shown in enlarged views of encircled portions denoted by T2 and T3 in FIG. 13, the rotational units 800 are attached individually to the shelf plate 220 at left and right sides of the keyboard chassis 500. As also shown in FIG. 14, the rotational unit 80 is provided substantially into a circular disk shape, and a screw hole 801 is provided in a center thereof. When viewed from the upper-lower direction UL, an external circumferential portion of the rotational unit 800 is formed into an annular wall portion 830 in which a first arc portion 810 of a convex arc shape and a second arc portion 820 of a convex arc shape, which is provided opposite to the first arc portion 810, are connected to each other into a straight line. In the annular wall portion 830, a side where the first arc portion 810 is disposed is provided taller in height than a side where the second arc portion 820 is disposed.

A cylindrical portion 802 is provided on an outer circumference of the screw hole 801 in such a manner that a head portion of the screw element 880 is accommodated in an interior of the cylindrical portion 802. Two annular convex portions 831, 832 are provided in a lower surface 805 of the rotational unit 800 concentrically with the screw hole 801. When the rotational unit 800 is set, the convex portions 831, 832 are brought into slidable contact with the upper surface of the shelf plate 220, thereby facilitating the rotation of the rotational unit 800.

The rotational units 800 are fixed to the shelf plate 220 with the screw element 880 via the screw hole 801 in positions lying near the left and right side surface plates 504 of the keyboard chassis 500 on the front side F of the keyboard chassis 500. In attaching the rotational unit 800, when the screw element 880 is rotated in a clockwise direction D1, the rotational unit 800 is also rotated in the clockwise direction D1 together with the screw element 880. Then, as shown in the enlarged view of the encircled portion denoted by T2 and an enlarged view of an encircled portion denoted by T3 in FIG. 13, the first arc portion 810 of the rotational unit 800 is brought into abutment with the side surface plate 504 on the left side L of the keyboard chassis 500, and similarly, the first arc portion 810 is also brought into abutment with the side surface plate 504 on the right side R of the keyboard chassis 500. Then, the keyboard 50 (the keyboard chassis 500) is restricted from moving in the key alignment direction LR by the rotational units 800 by sufficiently tightening the screw elements 880 to such an extent that the rotational units 800 are not rotated easily.

As has been described heretofore, with the embodiment of the present disclosure, the keyboard instrument fabricating method or the method for fabricating the keyboard instrument 10 is a method for fabricating the keyboard instrument 10 which is configured to assemble the keyboard 50 including the multiple keys (the white keys 300, the black keys 400) into the instrument case 200 through the concave-convex engagement structure which includes the concave groove portion 225 provided on either of the keyboard 50 and the instrument case 200 and including the left-right groove 225a and the front-back groove 225b configured to communicate with the left-right groove 225a and the convex portion 630 provided on the other of the keyboard 50 and the instrument case 200 and configured to be brought into engagement with the concave groove portion 225, and the keyboard instrument fabricating method includes the front-back groove engagement step of bringing the convex portion 630 into engagement with the front-back groove 225b and the left-right groove engagement step of bringing the convex portion 630 into engagement with the left-right groove 225a.

With this method for fabricating the keyboard instrument 10, the keyboard 50 can be restricted from moving relative to the shelf plate 220 without performing the screw tightening work from the lower side of the instrument case 200 only by performing the sliding operation of the keyboard 50 (or the shelf plate 220 of the instrument case 200), whereby the necessity of performing the screw tightening work from the lower side of the instrument case 200 can be obviated. Hence, the method for fabricating the keyboard instrument 10 with good assembly can be provided.

In the concave-convex engagement structure of the present embodiment, the convex portion 630 is provided on the keyboard 50 (the mount 600), while the concave groove portion 225 is provided in the instrument case 200 (the shelf plate 220). However, the present embodiment is not limited thereto, and hence, the concave groove portion may be provided in the keyboard 50, while the convex portion may be provided on the instrument case 200.

The keyboard 50 includes the keyboard chassis 500 for supporting the multiple keys (the white keys 300, the black keys 400) and the mount 600 configured to be provided in the interior of the keyboard chassis 500, and the front-back groove engagement step includes the step of disposing the mount 600 in the instrument case 200 in alignment with the first marking portion 221 provided in the instrument case 200. With this configuration, the concave-convex structure can be provided between the mount 600 and the instrument case 200 (the shelf plate 220), thereby making it possible to provide the structure in which the keyboard chassis 500 including thereon the constituent components (the sliding rubbers 350, 400, the circuit board 80, and the like) for the multiple keys is restricted from moving in the front-back direction FB by the mount 600. Then, even though the concave-convex engagement structure is disposed in a position invisible from the outside, a concave-convex engagement can be effected by disposing the mount 600 in such a manner that for example, a corner portion of the mount 600 is disposed in alignment with the first marking portion 221 which is visible from the outside.

The front-back groove engagement step includes the step of disposing the keyboard chassis 500 in alignment with the second marking portion 222 provided on the instrument case 200a to dispose the keyboard chassis 500 on an upper side UP of the mount 600.

With this configuration, even though it is difficult to align the keyboard chassis 500 with the mount 600, the keyboard chassis 500 can easily be attached to the mount 600.

The front-back groove engagement step includes the keyboard insertion step of inserting the part of the keyboard 50 into the gap defined between the front connector unit 201, which is the connector unit provided in the instrument case 200, and the shelf plate 220 of the instrument case 200. With this configuration, the keyboard 50 can be restricted from moving in at least one direction (the upper-lower direction UL in the present embodiment) with respect to the instrument case 200 without requiring a screw tightening step.

The method for fabricating the keyboard instrument 10 has, after the front-back groove engagement step and the left-right groove engagement step, a keyboard fixing step of rotating the rotational unit provided at at least one end of the keyboard 50 in an alignment direction LR of a key to thereby fix the keyboard 50 to the instrument case 200. With this configuration, the keyboard 50 can easily be restricted from moving in the alignment direction LR of a key.

The keyboard instrument 10 includes the instrument case 200 including either of the concave groove portion 225 including the left-right groove 225a and the front-back groove 225b configured to communicate with the left-right groove 225a and the convex portion 630 configured to be brought into engagement with the concave groove portion 225 and the keyboard 50 disposed within the instrument case 200 and including the other of the concave groove portion 225 and the convex portion 630, and the instrument case 200 and the keyboard 50 are brought into engagement with each other through the engagement structure made up of the concave groove portion 225 and the convex portion 630 to thereby fix the keyboard 50 to the instrument case 200.

With this keyboard instrument 10, the keyboard 50 can be restricted from moving relative to the instrument case 200 by performing the sliding operation, whereby the necessity of performing the screw tightening work from the lower side of the instrument case 200 can be obviated. Hence, the keyboard instrument 10 that can provide good assembly of a keyboard 50 into an instrument case 200 can be provided.

The keyboard 50 includes the keyboard chassis 500 for supporting the multiple keys (the white keys 300, the black keys 400) and the mount 600 provided in the interior of the keyboard chassis 500, and the other of the concave groove portion 225 and the convex portion 630 is provided on the mount 600.

With this configuration, the concave-convex structure can be provided between the mount 600 and the shelf plate 220, thereby making it possible to provide the structure in which the constituent components (the sliding rubbers 350, 400, the circuit board 80, and the like) for the multiple keys are provided on the keyboard chassis 500, and the keyboard chassis 500 is restricted from moving by the mount 600.

The concave groove portion 225 is provided into the L shape in which the left-right groove 225a is disposed on the front side F. With this configuration, the gap management with the right wing 207 and the like at the right side R at which the player tends to look more than the left side L is made precise, whereby the keyboard instrument 10 cab be provided in which the aesthetic appearance is enhanced.

The concave groove portion 225 is provided on the upper surface of the shelf plate 220 which is provided on the lower side of the instrument case 200, and the shelf plate 220 has the marking portion 226 which is disposed into the L shape resulting from rotating the concave groove portion 225 having the L shape through 180 degrees and having the same width as the width of the concave groove portion 225, the marking portion 226 constituting a guide for placing the keyboard 50 on the instrument case 200. With this configuration, the marking portion 226 constituting the guide for disposing the mount 600 and the keyboard chassis 500 can be provided by being machined in the same process as the process of providing the concave groove portion 225. Hence, the keyboard instrument 10 with good quality can be fabricated.

With the keyboard instrument 10, the keyboard 50 is fixed to the instrument case 200 in such a state that the locking plate 510, which constitutes the part of the keyboard 50, is inserted into the gap defined between the connector unit (the front connector unit 201) provided in the instrument case 200 and the shelf plate 220 of the instrument case 200. With this configuration, the keyboard instrument 10 can be provided which can easily be assembled up and in which the keyboard 50 can be restricted from moving by performing the sliding operation.

In the present embodiment, the step is exemplified in which the left-right groove engagement step is executed after the front-back groove engagement step. However, the present embodiment is not limited thereto, and hence, for example, in the case that the structure of the keyboard instrument differs from the structure thereof which is described in the present embodiment, the front-back groove engagement step may be executed after the left-right groove engagement step. The positional relationship between the front-back groove and the left-right groove is not limited to the positional relationship exemplified in the present embodiment.

What is claimed is:

1. A keyboard instrument fabricating method for assembling a keyboard comprising multiple keys into an instrument case through a concave-convex engagement structure,
wherein the concave-convex engagement structure comprises a concave groove portion and a convex portion,
wherein the concave groove portion is provided on either of the keyboard and the instrument case and comprises a left-right groove and a front-back groove configured to communicate with the left-right groove,
wherein the convex portion is provided on the other of the keyboard and the instrument case and is configured to be brought into engagement with the concave groove portion,
the keyboard instrument fabricating method comprising:
a front-back groove engagement step of bringing the convex portion into engagement with the front-back groove; and
a left-right groove engagement step of bringing the convex portion into engagement with the left-right groove.

2. The keyboard instrument fabricating method according to claim 1,
wherein the keyboard comprises a keyboard chassis for supporting the multiple keys and a mount configured to be provided in an interior of the keyboard chassis, and
wherein the front-back groove engagement step comprises a step of disposing the mount in the instrument case in alignment with a first marking portion provided on the instrument case.

3. The keyboard instrument fabricating method according to claim 2,
wherein the front-back groove engagement step comprises a step of disposing the keyboard chassis in alignment with a second marking portion provided on the instrument case to dispose the keyboard chassis on an upper side of the mount.

4. The keyboard instrument fabricating method according to claim 3,
wherein the step of disposing the keyboard chassis in alignment with the second marking portion to dispose the keyboard chassis on an upper side of the mount is performed after the step of disposing the mount in the instrument case in alignment with the first marking portion.

5. The keyboard instrument fabricating method according to claim 1,
wherein the front-back groove engagement step comprises a keyboard insertion step of inserting a part of the keyboard into a gap defined between a connector unit provided in the instrument case and a shelf plate of the instrument case.

6. The keyboard instrument fabricating method according to claim 1,
wherein the left-right groove engagement step is performed after the front-back groove engagement step.

7. The keyboard instrument fabricating method according to claim 1, comprising after the front-back grove engagement step and the left-right groove engagement step:
a keyboard fixing step of rotating a rotational unit provided at least at one end of the keyboard in an alignment direction of a key to thereby fix the keyboard to the instrument case.

8. A keyboard instrument comprising:
an instrument case comprising either of a concave groove portion and a convex portion,
wherein the concave groove portion comprises a left-right groove and a front-back groove configured to communicate with the left-right groove,
wherein the convex portion is configured to be brought into engagement with the concave groove portion; and
a keyboard disposed within the instrument case and comprising the other of the concave groove portion and the convex portion,
wherein the instrument case and the keyboard are brought into engagement with each other through an engagement structure made up of the concave groove portion and the convex portion to thereby fix the keyboard to the instrument case.

9. The keyboard instrument according to claim 8,
wherein the keyboard comprises a keyboard chassis for supporting multiple keys and a mount provided in an interior of the keyboard chassis, and
wherein the other of the concave groove portion and the convex portion is provided on the mount.

10. The keyboard instrument according to claim 9,
wherein the concave groove portion is provided into an L shape in which the left-right groove is disposed on a front side in a front-back direction of a key.

11. The keyboard instrument according to claim 8,
wherein the convex portion is provided substantially into a cylindrical shape, and
wherein an outside diameter of the convex portion is provided smaller than a groove width of the concave groove portion.

12. The keyboard instrument according to claim 10,
wherein the concave groove portion is provided on an upper surface of a shelf plate which is provided on a lower side of the instrument case, and
wherein the shelf plate comprises a marking portion which is disposed into an L shape resulting from rotating the concave groove portion having the L shape through 180 degrees and having a same width as a width of the concave groove portion, the marking portion 226 used for placing the keyboard on the instrument case.

13. The keyboard instrument according to claim 12,
wherein the concave groove portion comprises multiple concave groove portions which are provided on an upper surface of the shelf plate in such a manner as to be aligned in an alignment direction of the key.

14. The key board instrument according to claim 12,
wherein the marking portion comprises multiple marking portions which are provided on an upper surface of the shelf plate in such a manner as to be aligned in a front-back direction of the key.

15. The keyboard instrument according to claim 14,
wherein the marking portion is provided at one end portion in an alignment direction of the key.

16. The keyboard instrument according to claim 8,
wherein the keyboard is fixed to the instrument case in such a state that a part of the keyboard is inserted into a gap defined between a connector unit provided in the instrument case and a shelf plate of the instrument case.
